(19) United States
(12) Patent Application Publication
(10) Pub. No.: US 2012/0185325 A1
(43) Pub. Date: Jul. 19, 2012

(54) Method and system for distributed marketing displays on municipal parking meters

(75) Inventor: Daniel Shani, Newton, MA (US)

(73) Assignee: Vertical Ground, LLC, Newton, MA (US)

(21) Appl. No.: 12/930,850

(22) Filed: Jan. 19, 2011

(51) Int. Cl. G06Q 30/02; G03H 1/22

(52) U.S. Cl. 705/14.43; 705/14.71; 359/32

(57) ABSTRACT

Marketing communications are delivered by advertising displays affixed to or surrounding vehicular parking meters. Lease arrangements are determined by a machine-based method providing equitable revenue sharing to municipality or other entity owning the parking meter spaces and the marketing communication entity while providing rapid, reliable deployment to advertisers via a machine-based method of RFID tracking and deployment.

### PRIOR APPLICATION

This present application claims under 35 U.S.C. 119(e) the benefit of the prior filing date of Application number 61401427081110 filed on Aug. 11, 2010.

### REFERENCES CITED

US PATENT DOCUMENTS

| | | Issue/ | US |
|---|---|---|---|
| Number | Inventors | Publication Date | Classification |
| 2,554,923 | Reitz | May 1951 | |
| 4,453,325 | Ofsowitz et al. | June 1984 | 40/333 |
| 4,742,630 | Scumaci | May 1988 | 40/333 |
| 4,872,149 | Speas | October 1989 | 368/90 |
| 7,292,559 | Yoshino and Shimizu | November 2007 | 370/338 |
| 2010/0010887 | Karlin and Wang | January 2010 | 440/9 |
| 2010/0211491 | Kagan et al. | August 2010 | 705/34 |

### TECHNICAL FIELD

The present invention relates generally to display advertising, including digital display advertising. More particularly, the present invention relates to displaying advertising messages on structures affixed to or surrounding vehicular parking meters in an outdoor context.

### BACKGROUND

Advertisers are keenly interested in generating the most consumer attention to their products and services as possible. These companies invest tremendous resources in identifying and categorizing consumer interests, in order to create effective advertising messages. By using outdoor digital display advertising one can reach consumers in multiple high-value locations that current technology cannot reach. In addition, by using digital techniques including holographic techniques in such advertising one can reach a larger audience and create a more engaging customer experience.

Firstly, conventional means of displaying advertising messages are limited in terms of location. An example is highway billboards, which are limited as to where they can be placed, by the need to apply paint and erect billboards in such locations as the side of highways and conventional means are one-dimensional and can pose a safety risk as viewers must look off-road to see the messages. Moreover, the consumer experience is not engaging. Multiple chances to reach consumers are lost as conventional advertising techniques cannot be successfully applied in many areas where consumers are located. A related problem with conventional display advertising is that it is limited in size and shape. The size and shape limitations of conventional display advertising limit where it can be installed and how effectively it can project an image.

Secondly, conventional display advertising requires significant maintenance and repair and takes considerable time to install and to replace. Thus valuable time that could be used to display additional advertising is taken up with maintaining signage, repairing signage, installing signage, and replacing signage.

Thirdly, the conventional approach to display advertising misses multiple opportunities to reach consumers in centrally located, highly visible places. Conventional advertising has limited time to reach consumers. The present invention does not have such a “short-lived touchpoint”. One of the problems with the conventional approach is that drivers must look away from the road to see billboards hundreds of feet from the road which poses safety concerns and leads many drivers to ignore display advertising adjacent to highways.

Fourthly, the conventional approach to display advertising is problematic in that there is no easy way to track signage except by sending a crew to inspect the installation. Such a limitation is due in part to the static and one-dimensional nature of conventional display advertising. In addition, no added functionality, such as a solar panels or traffic sensors or temperature sensors or weather sensors, is included in a conventional installation of display advertising. The present invention has added marketing communication value and functionality and can collect and transmit onsite operational data. The present invention can be engineered to be safer than conventional display advertising and creates a more engaging consumer experience.

Accordingly, what is needed is the ability to install digital display advertising in more centrally located, highly visible places to attract more consumer attention to the advertisers' message. Further, it is desirable to include additional functionality in display advertising installations. Moreover, via RFID technology, it is desirable to track such installations, e.g., status of each installation, if some installations are not operational to be able to diagnose each affected installation, what is being displayed at each installation, and for what amount of time each advertising message has been shown at each location. On digital displays, advertising messages could be changed via a wireless network. The combination of digital advertising displays, magnets, holographic technology, and RFID technology and their joint application in the field of display advertising for vehicular parking meters is novel.

### SUMMARY

According to a preferred embodiment, by installing additional functionality during the construction of a display advertising location, it would be possible to power attached LEDs via attached solar panels, to display weather conditions, to display temperature conditions, to display road conditions, to display traffic conditions using CCD sensors, and to, via RFID sensors and associated software, track the status of the display advertising installations and update the messages. By adding greater value and multiple dimensions to existing structures, it is demonstrable that the present invention is malleable and adaptable to multiple environments. All of the additional functionalities are novel applications to existing structures and highlight that the present invention can be adapted to multiple environments and can meet many needs. The invention can take advantage of existing structures, e.g., vehicular parking meters, and so constitutes an environmentally green invention as a result. The invention is very sustainable: it does not need major construction of installations but rather efficiently makes use of existing resources, protects underlying structures from weathering and from corrosion, the process used incorporates green, environmentally sustainable, materials and processes in the development, installation, and maintenance of signage, and there are features which add value such as solar power generation, data collection from signage and redistribution of that data via a software-driven process, and the ability to make real time display adjustments at a given installation.

The details of one or more embodiments are set forth in the accompanying drawings and descriptions below. Other features, objects, and advantages will be apparent from the description and drawings.

### BRIEF DESCRIPTION OF THE DRAWINGS

FIG. 1. Cross section of Marketing Display Sign

FIG. 2. Schematic Layout of Sensing System on Marketing Display Sign

FIG. 3. Schematic Layout of Sensing System Components

FIG. 4. Sensing System of Marketing Display Sign: Vertical Cross Section of CCD Camera

FIG. 5. Schematic Diagram of RFID Communication System

FIG. 6. Computer-based Method for Selection and Customization of Signage

FIG. 7. Marketing Communication Kiosk: Perspective View

FIG. 8. Marketing Communication Kiosk: Cross Section View

FIG. 9. Marketing Communication Kiosk: Cross Section View

FIG. 10. Marketing Communication Kiosk: Base Plate

FIG. 11. Marketing Communication Kiosk: Flat Panel Displays

FIG. 12. Marketing Communication Kiosk: Multi-Panel Displays

FIG. 13 System For Conducting The Auction of Display Advertising Space Leases

### DETAILED DESCRIPTION OF THE PREFERRED EMBODIMENT

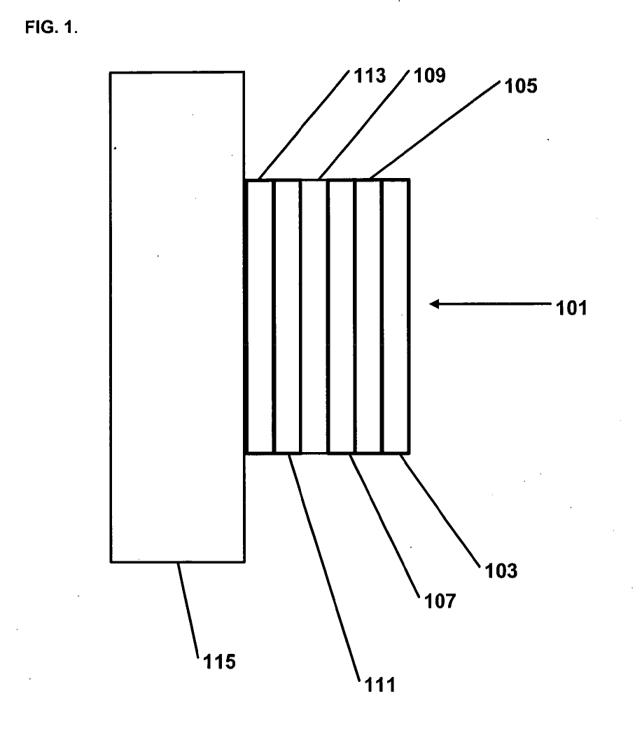

The present invention can be implemented in any polygonal shape and provides for display advertising employing a sign 101 with a plurality of layers as shown in FIG. 1. The portion labeled 113, the back protective layer of the advertising display, would be affixed by magnetic force to the metal surface 115 on which the magnetic display advertising is to be mounted and would protect the metal surface as well as the magnetic material from exposure to the corroding elements in the atmosphere. On this layer a reflective pigment or light-emitting diodes would be placed, as a bottom strip on the magnetic display advertising installation to be visible in the absence of strong natural light. The portion labeled 111 would be the magnetic layer in front of which in a portion of the sign would be the RFID sensors for use in the tracking system.

The portion labeled 109, the graphical layer of printed images or digital display, in front of the magnetic layer comprises, in the case of digital displays, a plurality of LEDs powered by an attached solar panel. Signage with a combination of digital and print images would also have LEDs powered by attached solar panels that store electricity in lithium ion batteries. Such a power source would allow the sign to continue to operate if there was a power failure in the area. In addition, LEDs could be used to indicate availability of parking meters, e.g., green for available and red for in use. Moreover, LEDs could indicate time remaining on a parking meter, e.g., yellow to show more than 10 minutes remaining with orange to show less than 10 minutes remaining. The portions labeled 107, 105 are where a holographic or digital layer would be placed on the advertising image to allow changes with position of the observer. The portion labeled 103 would be the front protective layer protecting display materials from damage caused by natural elements. On the front surface portion of 101 a CCD camera would be placed to record weather and traffic conditions or other events of interest. Moreover, CCD cameras would be useful for security video surveillance to combat street crime and violence. In addition, CCD cameras would count and monitor pedestrian and vehicular traffic.

It will be appreciated that terms such as “left”, “right”, “top”, “bottom”, “inwardly”, “outwardly”, “front”, “inner”, “up”, and “down” and other positional descriptive terms used hereinabove or herein below are used merely for ease of description and refer to the orientation of the components as shown in the Figures. It should be understood that any orientation of the elements described herein is within the scope of the present invention. In addition, like numerals refer to like parts throughout the several views of the drawings.

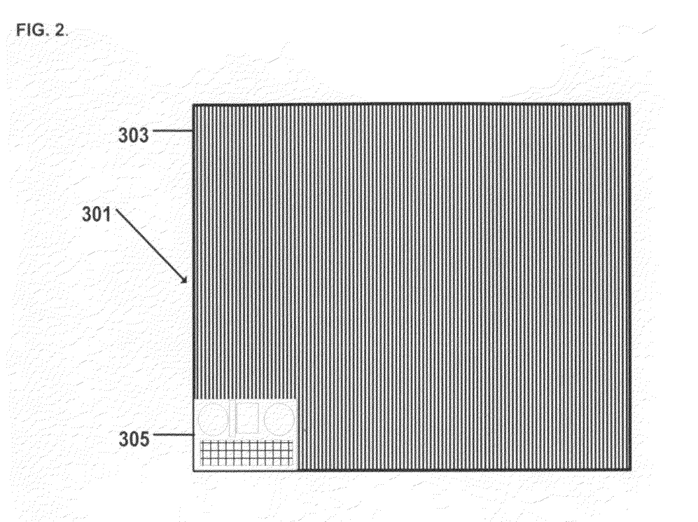

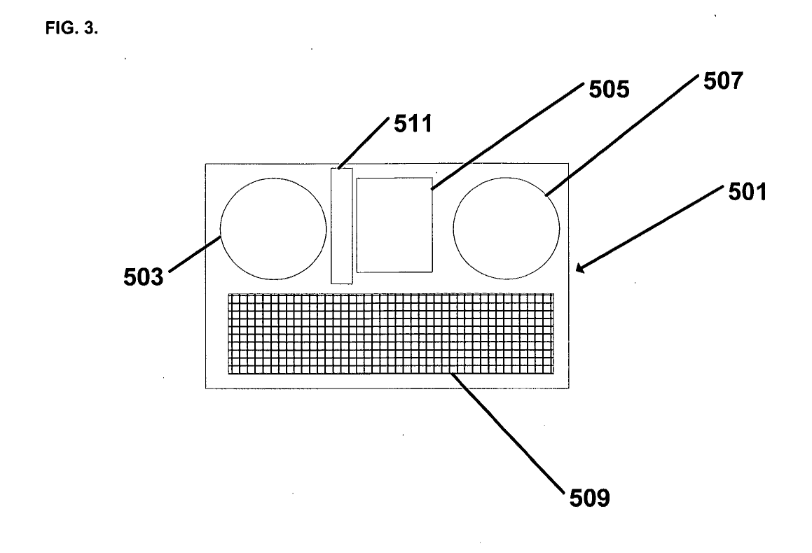

As shown in FIG. 2, the Marketing Display Sign 301 comprises at least one sensing system 305 embedded in the display advertising sign 303. Said sensing system as shown in FIG. 3 includes a weather sensor labeled 503 to detect the presence of high winds, rain, and snow and to detect how cold or hot the installation is at that moment in time, at least one CCD camera labeled 511 that can serve as a traffic sensor used to detect the volume of vehicles or observers passing the sign per minute, and an active RFID sensor labeled 507 which detects the condition of the sign and, if there is a malfunction with the sign, detects what type of malfunction, e.g., freezing temperature, vandalism, some manner of vehicular accident, as well as which messages are being shown, and how recently said messages were installed at that location. Via a digital transmission system replacement advertising messages could be sent out to display advertising installations. The Sensing System 501 is powered by a solar panel 509 supplemented by a Lithium Ion battery 505. Moreover, the display system can use these power sources to illuminate the sign when visibility is poor, e.g., after sunset, on foggy days, and on cloudy days.

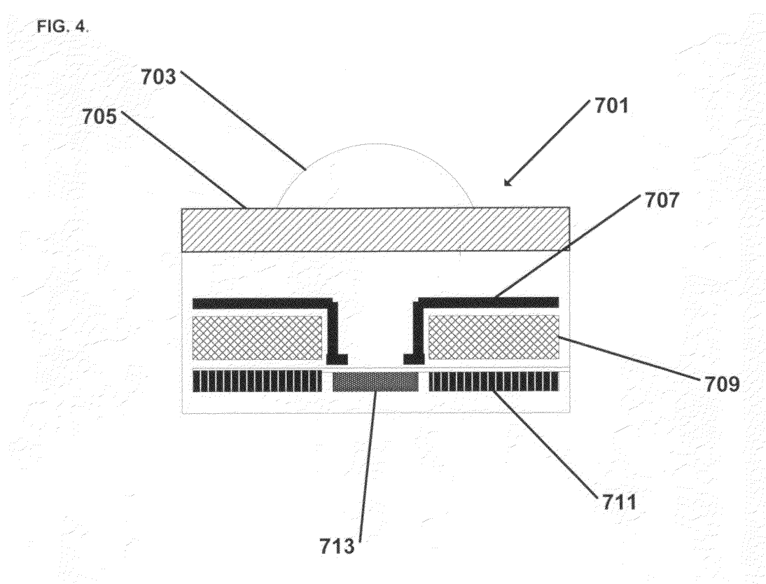

The CCD Camera 511 shown in FIG. 3 is depicted in vertical cross section in FIG. 4. A CCD Camera 701 is equipped with a microlens 703 in front of an optical filter 705. Images are focused by the microlens 703 onto the CCD sensor 713 with the stray or scatter light blocked by a photo-shielding film 707. Said camera system will be used to collect images that image processing software can recognize pedestrians or vehicles that could serve as proxies for viewers, for example, to estimate delivered advertising display impressions.

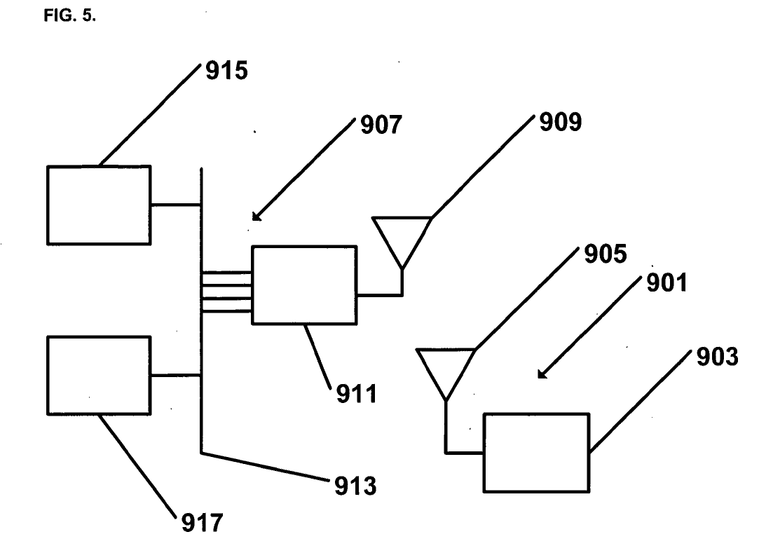

FIG. 5 illustrates the advertising display sign tracking system 901 comprising a network of servers 907 that receive input signals over a plurality of WiFi Access Points with RFID Readers 911 connected over a secure internet portal 909 from a plurality of active sensor systems connected to a secure internet portal. The active RFID sensor 903 would send signals to the position tracking server 917 used by tracking software system 915 to track the installations of display advertising and monitor the operational status of each installation, e.g., the designation of the advertising content being shown. in each location. The tracking system communicates alert messages when signage needs to be changed or an installation needs repair or maintenance. Moreover, new advertising messages in digital form or stored by digital reference could be sent to display advertising installations via this system. This computer system is used as part of a computer-based business method to track signs, i.e., to determine condition of signage, to determine which messages are being displayed at which installations, and to determine how long the messages have been displayed at each location. This system could also be used to update advertising messages based on information collected from signage. The component labeled 909 represents a web server that can access a global networking system such as the internet. The portion labeled 915 represents a database server with display system database and associated applications. FIG. 5 is an illustration of the attached sensor and electronic devices that are included in magnetic display advertising. The portion labeled 903 is a RFID tag. Such tags enable a wireless network infrastructure to accurately track the location and condition of the display advertising installations. The RFID sensor is small, battery powered, and programmable. Such sensors send short 802.11b messages at predefined intervals to a wireless network. The sensors last for up to 5 years, can be mounted in many locations, are compact, are durable, and have the capacity to store and receive data messages. Each outdoor, magnetic, display advertising installation would have an ultralow power Wi-Fi-based tamper-proof active RFID tag. This RFID tag would be powered by one or more long-lasting rechargeable lithium batteries 505, on FIG. 3, which can last up to 5 years. Or the outdoor, magnetic, advertising installation could be powered by a solar panel, labeled 509 on FIG. 3, feeding into a rechargeable lithium battery. The RFID tags would monitor the environment and gather useful information, including, but not limited to, weather data, temperature data, traffic volume data, motion and condition of the signage data, as well as transmit location information via GPS.

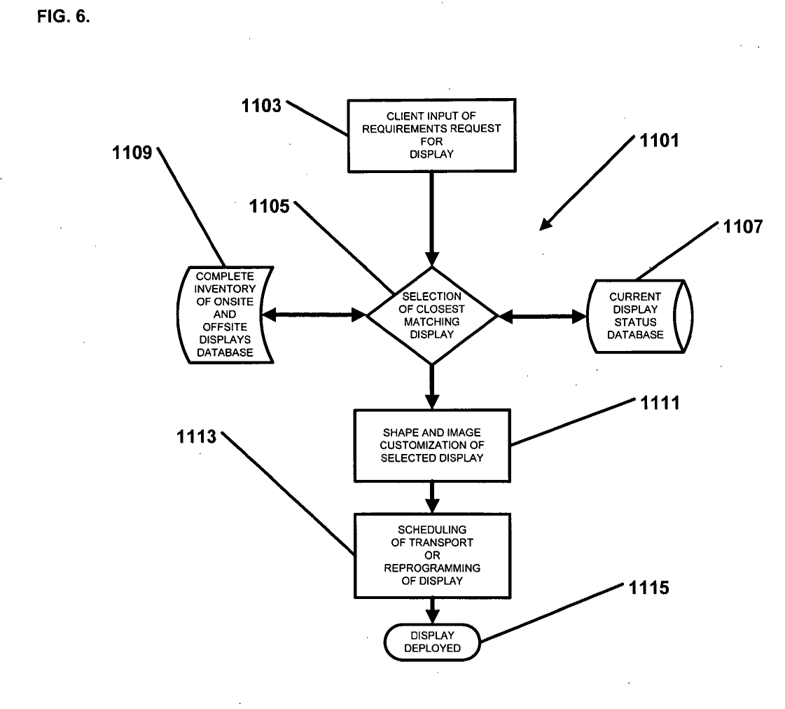

A computer-based system 1101 is used to optimize signage's dimensions, color, shape, lights, font size, pigment, and other aspects to best fit a given installation as shown in FIG. 6. This computer system is used as part of a machine-based business method to configure signs, i.e., locate the correct shape for a given installation in a database or, if said shape is not in the database, the software creates a printing master to optimally fit the space at the location. By thus optimizing the images so that they match the particular location of each installation greater marketing impact is achieved. The computer system would check inventory, on the database, labeled 1107, and on the distributed database cluster, labeled 1109, to determine if a suitably shaped magnetic advertising display already existed in the database. If no suitable shape was in the database, the computer system would configure the magnetic display advertising materials so as to fit the space at the proposed installation location optimally. The portion labeled 1103 represents a request from a plurality of clients. The portion labeled 1109 represents a database of shapes and signs in inventory; this database can be located centrally or be accessible via the internet. The portion labeled 1107 represents a continually updated database of the status of deployed display systems. The portion labeled 1105 represents the decision module for determining the existence of a sign in the inventory and its current status in the field using the RFID tracking application. The portion labeled 1111 represents an application for customizing the shape of the advertisement to the available space at the location. The portion labeled 1113 represents the reprogramming of the display or scheduling of the transport of an existing sign to the required location. The portion labeled 1115 is the output indicating that the display has been deployed automatically over the internet in the case of reprogramming an existing sign or a message dispatched to workers to redeploy a display system to a new location.

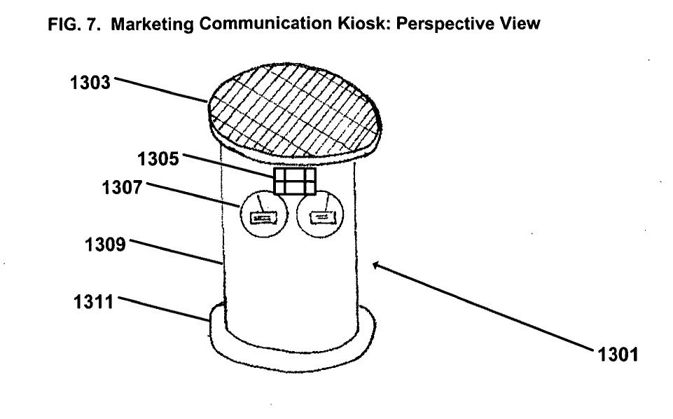

Municipal government and other entities employ pre-paid vehicular parking meters to provide short-term parking areas, principally for consumers; and as a source of revenue from pre-payments and fines. Such parking meters constitute locations where advertising displays could be located providing satisfactory arrangements could be made with the government entity in charge of the signs. At the same time consumers or others parking vehicles would react favorably to free parking. The present invention provides a means for advertisers to lease display space and provide free parking. The machine-based business method arrives at a three-way mutually satisfactory display lease rate: satisfactory to the advertiser based on ROI or other measure; satisfactory to the owner of the parking meter(s) usually a municipality for the proportion of the revenues it receives; and satisfactory to commercial entity arranging the leases and coordinating the displays for the proportion of the lease fee they receive. The present invention can be implemented in any polygonal shape such as that shown in FIG. 7. As shown in that figure the present invention provides for magnetic display advertising employing an advertising display kiosk 1301 with a plurality of attachments. The portion labeled 1303, the solar energy panel, would be affixed by magnetic force to the advertising display kiosk 1301 on which the magnetic display advertising is to be mounted and protect the metal surface as well as the magnetic material from exposure to the corroding elements in the atmosphere. Below the solar energy panel 1303 would be placed the sensing and communication panel 1305 which is further shown in FIG. 3. Below the sensing and communication panel 1305 and on each side of it would be placed two holes in the display advertising installation 1307. These two holes would allow access to the parking meter despite the surrounding display advertising installation so that parking drivers could buy more time than the free 60 minute period. Consumers could purchase time at central payment boxes and the display advertising installation would indicate where the central payment boxes were located. Moreover, parkers could use smartphone connectivity, from such devices as iPhones, Blackberrys, Androids, to purchase additional time wirelessly using a mobile application or via texting. In addition, the advertising display installation would send a text message to parked drivers, if they had registered their cell phone or personal digital assistant on parking, near the expiration of the time, i.e., the free 60 minutes plus any purchased time, on the parking meter. Further down the advertising display kiosk 1301 would be placed a marketing communication display 1309 and at the base of the advertising display kiosk 1301 would be located a base for affixing the advertising display kiosk to the sidewalk.

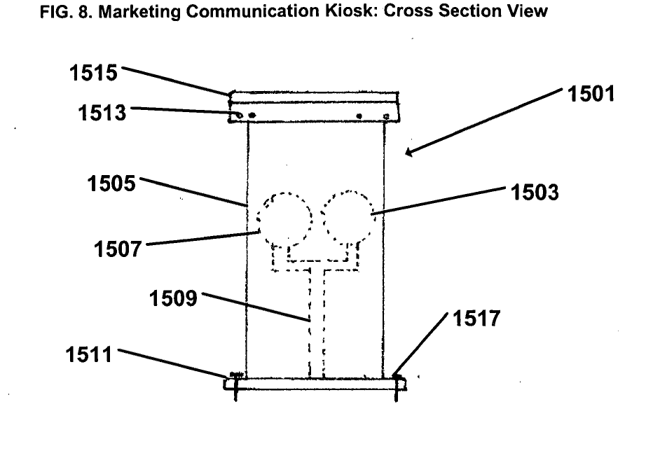

As shown in FIG. 8, a cross section of the advertising display kiosk 1501 has multiple portions. The present invention can be implemented in any polygonal shape and the portion labeled 1503 is the right side of the parking meter inside the advertising display kiosk 1501. The portion labeled 1505 is the marketing communication display and the portion labeled 1507 is the left side of the parking meter inside the advertising display kiosk 1501. The portion labeled 1509 is the support column portion of the parking meter. The portion labeled 1511 is the base of the advertising display kiosk and the portion labeled 1513 is where the LEDs would be displayed. The portion labeled 1515 is the solar energy panel.

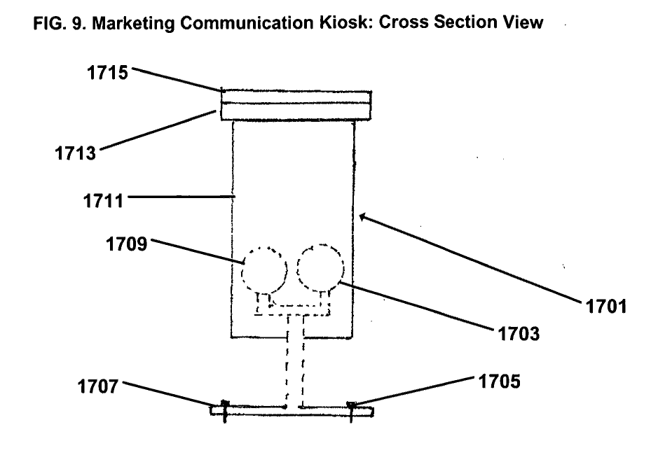

As shown in FIG. 9, a cross section of the advertising display kiosk 1701 not fully enclosing a parking meter, there are a plurality of components of an advertising display kiosk 1701. The present invention can be implemented in any polygonal shape and the portion labeled 1703 is the right side of the portion of the parking meter surrounded by the advertising display kiosk 1701. The portion labeled 1705 represents the bolt for affixing a support column. The portion labeled 1707 represents the base of the advertising display kiosk 1701. The portion labeled 1709 is the left side of the portion of the parking meter surrounded by the advertising display kiosk 1701. The display LEDs are shown in the portion labeled 1713. The portion labeled 1715 represents a solar energy panel on top of the advertising display kiosk 1701.

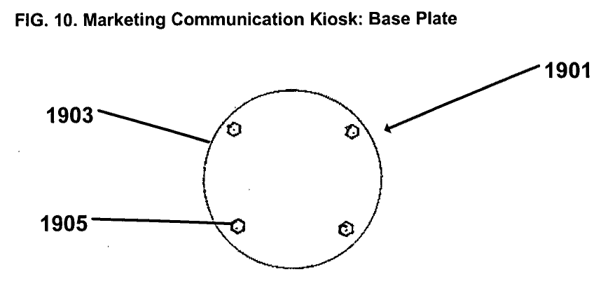

FIG. 10 shows the base plate of the marketing communication kiosk. The present invention can be implemented in any polygonal shape and the portion labeled 1901 is the base of the kiosk. The portion labeled 1903 is the base plate for affixing a support column and the portion labeled 1905 is the bolt for affixing a support column.

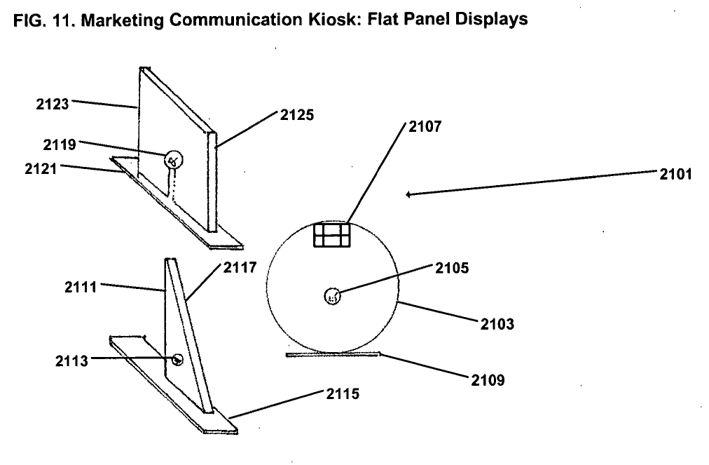

FIG. 11 shows a view of flat panel displays of the marketing communications kiosk. The present invention can be implemented in any polygonal shape and the portion labeled 2101 is the advertising display kiosk as a whole. The portion labeled 2103 is the marketing communication display. The portion labeled 2105 is the right side of the parking meter inside the advertising display kiosk 2101. The portion labeled 2107 is the sensing and communication panel. The portion labeled 2109 is the base of the advertising display kiosk 2101. The portion labeled 2111 is the marketing communication display on the pedestrian-facing side. The portion labeled 2113 is the left side of the parking meter inside the advertising display kiosk 2101. The portion labeled 2115 represents the base of the kiosk. The portion labeled 2117 is the marketing communication display on the motorist-facing side. The portion labeled 2119 is the parking meter inside the advertising display kiosk 2101 with support column. The portion labeled 2121 is the base of the kiosk. The portion labeled 2123 is the marketing communication display on the pedestrian-facing side. The portion labeled 2125 is the marketing communication display on the motorist-facing side.

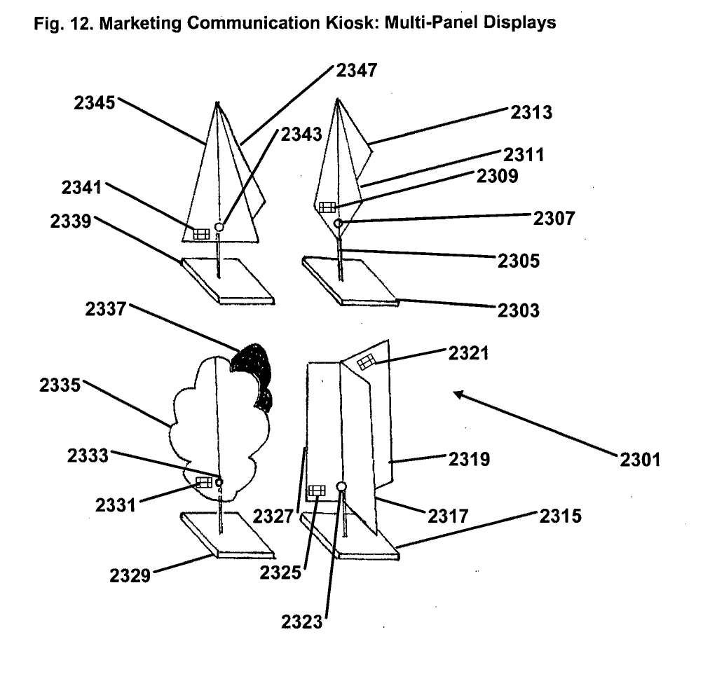

FIG. 12 shows the multi-panel display of the marketing communication kiosk. The present invention can be implemented in any polygonal shape and the portion labeled 2301 is the advertising display kiosk. The portion labeled 2303 is the base of the kiosk marketing communication display. The portion labeled 2305 is the support column for the parking meter inside the advertising display kiosk 2301 and the portion labeled 2307 is the parking meter inside the advertising display kiosk 2301. The portion labeled 2309 represents a sensing and communication panel and the portion labeled 2311 represents a marketing communication display as does the portion labeled 2313. The portion labeled 2315 is the base of the kiosk marketing communication display. The portion labeled 2317 represents a marketing communication display. The portion labeled 2319 represents a marketing communication display. The portion labeled 2321 represents a sensing and communication panel. The portion labeled 2323 represents a parking meter inside the advertising display kiosk 2301. The portion labeled 2325 represents a sensing and communication panel. The portion labeled 2327 represents a marketing communication display. The portion labeled 2329 represents the base of the kiosk marketing communication display. The portion labeled 2331 represents a sensing and communication panel. The portion labeled 2333 represents a parking meter inside the advertising display kiosk 2301. The portion labeled 2335 represents a marketing communication display. The portion labeled 2337 represents a marketing communication display. The portion labeled 2339 represents the base of the kiosk marketing communication display. The portion labeled 2341 represents a sensing and communication panel. The portion labeled 2343 represents a parking meter inside the advertising display kiosk 2301. The portion labeled 2345 represents a marketing communication display. The portion labeled 2347 represents a marketing communication display.

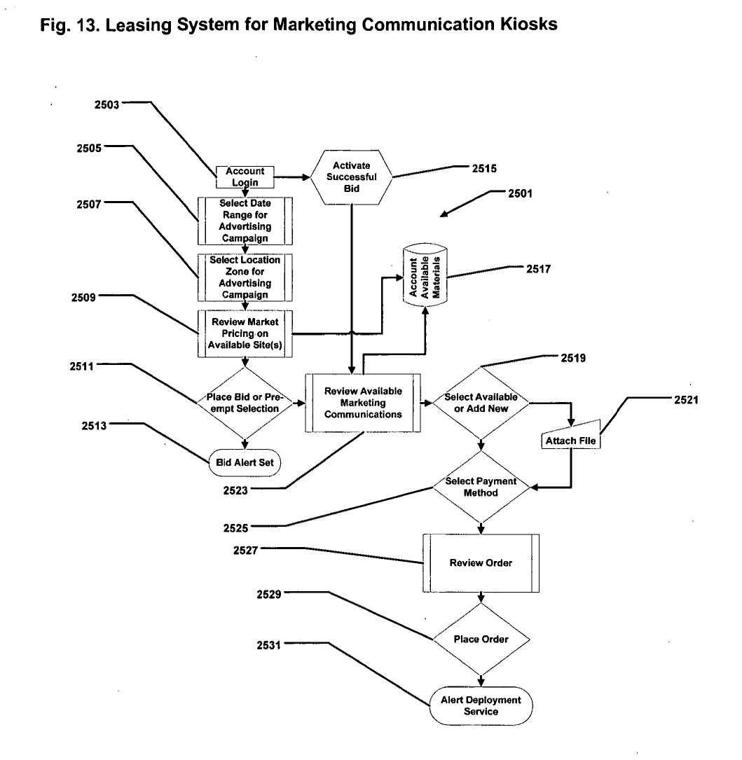

FIG. 13 represents the machine-based system or method of auctioning 2501 display advertising space lease affixed to or surrounding parking meters. Prospective advertisers would log onto the auction website to review and select locations, lease periods, and advertising materials. The computer system hosting the auction-based advertising display leasing market would function in the following manner. Interesting bidders would have access via the website to review available sites, i.e., defined as available within a specified period. A computer-based transactional database of leaseable properties would inform the bidder of time left on each auction and of the current highest bid on each auction or of the reserve bid if there were no previous bids. The location database supports an interactive graphical user interface showing lease properties searchable by specific street addresses and by click-select from a map showing all the installations on a given street, district, or Metropolitan Statistical Area (MSA). The database would use maps and satellite technology, e.g., Google maps and GPS, to identify businesses near parking meter installations to let bidders know what surrounds the parking meter installations. The bidders would select proposed marketing communications from those in the database or attach new advertising messages in electronic form. If the advertiser was the highest bidder in at least one auction the marketing communication would be displayed for the contracted period at the contracted rate; however, the advertiser for a premium could preempt the auction to secure the desired locations and time periods. Said network comprises a login step 2503 for securing access to the auction website using a communication protocol such as SSL with two-factor authentication with digital tokens. After authentication the advertiser or its agent would specify a desired date range or ranges 2505 and a desired location or location(s) 2507 to review. Then the web-based interface would allow the advertiser to review available auctions that fit given parameters such as location, date range, and price. After a review the advertiser would make a selection 2511 and chose to purchase time on a given display advertising installation or to bid in an auction or several auctions. A bid alert 2513 is set up in the database of the auction website. At this point if a bidder has entered a preemptive bid or subsequently won an auction a successful bid electronic message 2515 is sent to the bidder in question. The database of available marketing communications is represented by 2517. Available marketing communications 2523 are reviewed to determine if the desired marketing communication is within the available ones: if it is it is selected or if it is new it is added to the database 2519. At this point in the system or method the new file is attached 2521, then the payment method is selected 2525, then the order is reviewed by the user 2527, then an order is placed 2529, and finally the deployment system shown in FIG. 6 is alerted 2531. In addition, the auction server would be connected to the fee processing server which would send a portion of the winning bid to a bank server and send the remainder to the owner of the parking meter space, e.g., a municipality's server, which would send it on to a bank server. Moreover, a system using the CCD camera could track the parking of vehicles at the parking meters and place 60 minutes on the meter at the moment a vehicle parks. Said system allows additional time to be purchased by the parker and the system measures the passage of time and if more time elapses than shown on the timer a message with the license plate number and the amount of timer over the initial free 60 minutes, taking into account any extra time paid for, is sent to the municipality or other entity that owns the parking meter.

To warn parking drivers that the parking was only free for 60 minutes there would a small sign on a portion of the advertising display stating that fact. Additional mobile applications for personal digital assistants and smartphones to facilitate information transfer between parkers, pedestrians, store owners, advertisers are possible. The CCD camera at each installation would record the license plate of each parking car and transmit this information plus the time when the car was parked and the time when the car left the parking space to the municipality's server for issuance of necessary tickets. If the driver of the car chose to purchase more time the number of additional minutes paid for would be displayed on the parking meter and recorded by the CCD camera. These additional minutes would be added to the 60 free minutes so that a ticketing message would only be sent to the municipality when both 60 minutes and the additional purchased minutes had expired, i.e., when a car parked at a parking meter with associated display advertising the meter on the parking meter would set itself to 60 minutes and if more time was purchased this set number could be increased and the total number of minutes would be recorded and if exceeded a signal would be transmitted to the municipality or other owner indicating the license plate number and the amount of excessive parking minutes used.

In a preferred embodiment, each installation is fitted with RFID sensors which send signals to a software system that tracks the installations of display advertising and monitors the operational status of each installation and what is being shown in each location and this software sends signals out when signage needs to be changed or an installation needs repair or maintenance. New advertising messages can be digitally transmitted to the display advertising locations via this software system.

An advantage of this type of display advertising is that the manufacturing process to create the magnetic strips on which advertising is placed would be environmentally sustainable. The process does not use adhesives and polluting chemicals to hold the display in place. Moreover, recycling of the magnetic strips and their reuse is possible. In addition, the manufacturing process used to create the non-conventional display advertising magnetic strips is environmentally friendly and the materials used in manufacturing and those used in printing and those used in distribution are also environmentally friendly.

An advantage of the above methods is that advertising can be placed in many more locations which are centrally located and highly visible, but which are currently not served. Moreover, the installations using preexisting structures need significantly less time to install compared to the prior art. Some installations could be instantaneous. Such installations have much lower costs and disrupt their surroundings significantly less than a comparable prior art installation. Another advantage of the above method is that advanced digital technology enables the advertising installations to collect and distribute valuable information. Moreover, the above method enables the tracking of signage for maintenance and repair and replacement purposes much more easily via RFID and a software tracking process. Still another advantage of the invention is that it can be solar powered via a flat solar generator on the end of the magnet to self-sustain lighting thus avoiding the need for a conventional power source. Moreover, additional functionalities such as traffic condition sensors, temperature condition sensors, and weather condition sensors can be displayed next to the advertising message.

Still another advantage of the new magnetic display advertising is that the structure on which it is placed is protected from corrosion and deterioration via special coatings and special materials. The new magnetic display advertising not only avoids the need to install additional structures, but it protects the outer surface of existing structures from exposure to corrosive elements. This minimizes maintenance costs associated with repainting and caring for parking meters.

The embodiments of the invention in which an exclusive property or privilege is claimed are defined as follows:

1. An apparatus surrounding or affixed to vehicular parking meters for displaying marketing communications, comprising at least one marketing communication module, further comprising a plurality of layers: a layer of digital display elements, a layer of magnetic material, a layer of holographic material and at least one sensing and communication module.

2. The apparatus of claim 1, wherein the sensory and communication module(s) comprises a weather sensor; at least one traffic sensor; and active RFID sensors to detect conditions at the installation.

3. The apparatus of claim 1, wherein the solar energy panel(s) are connected to electrical storage device and are connected to light emitting diodes.

4. The apparatus of claim 1, wherein the marketing communication display comprises advertising messages deployed using holographic elements, light-emitting diodes, and graphic displays

5. The apparatus of claim 1, wherein the material used to display the advertising comprises magnetic material, wherein RFID sensors are placed on the magnetic material, and an optical detection system.

6. The apparatus of claim 1, wherein the advertising images comprise holographic images to allow changes with respect to the position of the observer of the image; wherein a sensing system is used to record conditions at the installation; and internet connectivity such that marketing communications can be transmitted to an installation and displayed.

7. A machine-based method for leasing parking meter displays, the method comprising: an auction website; a login step for securing access to said website; and a database of available sites for display advertising searchable by date range and location, and viewed on a map of each display advertising installation.

8. The method of claim 7 wherein the user of the auction website could take a variety of actions, comprising: reviewing available auctions given parameters such as location, date range, and price; exercising the option to purchase time on a display advertising location immediately or to bid in the auction(s) which action would cause a bid alert to be sent to the auction website; and if successful in bidding a message is sent to the winning bidder.

9. The method of claim 7 further comprising reviewing available marketing communications to determine if the desired marketing communication is in the database of marketing communications; if the desired marketing communication is within said database it is selected; and if the desired marketing communication is not in the database then there is the capability to add marketing communications in electronic form to said database.

10. The method of claim 7 further comprising attaching the new marketing communication file, selecting a payment method; and allowing the user to review the order.

11. The method of claim 7 further comprising placing an order, transmitting payment to the operator of the auction website; and further transmitting a portion of said payment to the municipality or other owner of the parking meter surrounding which the display advertising installation was placed.

12. The method of claim 7 further comprising transmitting a signal to the display advertising installations involving in a given auction when said auction is over; said transmission containing the time to start displaying the new marketing communication and the period to show the new marketing communication; and wherein the desired marketing communication is transmitted to the display advertising installations that were bid on during the auction from a marketing communication database.

13. The method of claim 7 further comprising transmitting message to installation worker to manually the marketing communication display; receipt of signal from workers indication completion of task; notification of bidding winner that marketing display is active.

14. A machine-based method for managing logistics of parking meter display inventory and deployment of said inventory and for optimizing the space of display advertising material to fit a given location and for transmitting data from a display advertising location to a central location and to transmitting data from said central location to display advertising locations, the method comprising: a database and distributed database cluster with records of all previous used marketing communications; software to optimize signage's dimensions, color, shape, lights, font size, pigment, and other aspects to a given location by creating a printing master; and means for said software to communicate to said database.

15. The method of claim 14, further comprising: configuring the magnetic display advertising, if necessary, so as to fit the space at the proposed installation optimally, receiving messages from installations via RFID as to the status of the deployed display systems, and, as needed, transmitting reprogramming to the display or transmitting a signal to transport an existing sign to a required location.

16. The method of claim 14, further comprising: an output which indicated that a display's marketing communication has been deployed automatically over the Internet or that workers have been notified to redeploy a display system to a new location; a network of servers to receive input signals over a plurality of WiFi Access Points with RFID readers; and wherein said RFID readers are connected via a secure Internet portal from a plurality of active sensor systems.

17. The method of claim 14, further comprising: active RFID sensors that transmit signals to a position tracking server; a tracking software system to record the operational status of each display advertising installation, i.e. the marketing communications being shown and when each communication was first shown and how long it has been shown; and communication means to transmit alert messages when signage needs to be changed or repair or maintenance of an display advertising installation is needed.

18. The method of claim 14, further comprising: storage for new marketing communications in digital form or via digital reference; means to monitor display advertising installations; and a system to update marketing communications based on information collected from a given display advertising installation.

19. The method of claim 14, further comprising: a web server that can access a global networking system such as the Internet or World Wide Web, a database server with a display system database and associated applications; and RFID sensors which could track the location and condition of display advertising installations.

20. The method of claim 14, further comprising: weather sensors; temperature sensors; traffic volume sensors; condition of display advertising installation sensors; and means to transmit information via GPS.
